(19) United States
(12) Patent Application Publication
(10) Pub. No.: US 2014/0175070 A1
(43) Pub. Date: Jun. 26, 2014

(54) LASER PROCESSING METHOD AND FINE PARTICLE LAYER FORMING AGENT

(71) Applicant: Disco Corporation, Tokyo (JP)

(72) Inventors: Yukinobu Ohura, Tokyo (JP); Daigo Shitabo, Tokyo (JP); Nobuyasu Kitahara, Tokyo (JP); Seiji Harada, Tokyo (JP)

(73) Assignee: Disco Corporation, Tokyo (JP)

(21) Appl. No.: 14/102,892

(22) Filed: Dec. 11, 2013

(30) Foreign Application Priority Data
Dec. 25, 2012 (JP) 2012-281357

(51) Int. Cl. B23K 26/18; B23K 26/36

(52) U.S. Cl. CPC B23K 26/18; B23K 26/367
USPC 219/121.69; 106/287.35

(57) ABSTRACT

A laser processing method including the steps of covering the back side of a workpiece with fine particles having absorptivity to the wavelength of a laser beam to be applied to the workpiece, thereby forming a fine particle layer on the back side of the workpiece, and next applying the laser beam through the fine particle layer to the back side of the workpiece to thereby perform ablation to the workpiece. The laser beam applied to the workpiece is absorbed by the fine particle layer to thereby suppress the scattering of the energy of the laser beam and the reflection of the laser beam, so that the ablation to the workpiece can be efficiently performed.

### BACKGROUND OF THE INVENTION

1. Field of the Invention

The present invention relates to a laser processing method of applying a laser beam to a workpiece to thereby perform ablation and also to a fine particle layer forming agent for use in the laser processing method.

2. Description of the Related Art

There has been proposed a technique of dividing a thin substrate such as a semiconductor wafer and a sapphire substrate into fine chips, wherein a laser beam is applied to the substrate as a workpiece along division lines to thereby perform ablation to the substrate along the division lines (see Japanese Patent Laid-open No. Hei 10-305420, for example). The ablation is a process of applying a laser beam having an absorption wavelength to a workpiece, thereby making the energy of the laser beam absorbed by the workpiece reach the band gap energy of the workpiece and accordingly breaking the atomic bond of the workpiece.

In performing the ablation, the energy of the laser beam is scattered and the laser beam is reflected on the surface of the workpiece where the laser beam enters, causing a problem that the energy of the laser beam applied to the workpiece is not sufficiently used for the ablation, resulting in large energy loss. Further, there is another problem such that the workpiece is melted because of the scattering of the energy to cause the generation of debris, which is scattered to contaminate the surface of the workpiece. As a technique for solving this problem, it is known that a protective film agent formed of a water-soluble material is applied to the surface of the workpiece to form a protective film on the surface of the workpiece, thereby preventing the debris from being directly deposited on the surface of the workpiece (see Japanese Patent Laid-open No. 2006-140311, for example).

### SUMMARY OF THE INVENTION

However, since the protective film is formed on the surface of the workpiece, the energy of the laser beam is scattered more to cause a reduction in processing efficiency.

It is therefore an object of the present invention to provide a laser processing method and a fine particle layer forming agent which can reduce the possibility of deposition of the debris due to ablation to the workpiece and can also improve the processing efficiency over the prior art.

In accordance with an aspect of the present invention, there is provided a laser processing method of applying a laser beam to a workpiece to thereby perform ablation, the laser processing method including a fine particle layer forming step of covering one side of the workpiece with fine particles having absorptivity to the wavelength of the laser beam to be applied to the workpiece, thereby forming a fine particle layer on the one side of the workpiece; and a processing step of applying the laser beam through the fine particle layer to the workpiece after performing the fine particle layer forming step, thereby performing the ablation to the one side of the workpiece.

Preferably, the fine particle layer includes the fine particles and an adhesion promoting liquid for promoting the adhesion of the fine particles to the one side of the workpiece. Preferably, the fine particle layer forming step includes a holding step of rotatably holding the workpiece on a spinner table; a coating step of supplying a liquid mixture to the one side of the workpiece after performing the holding step, thereby coating the one side of the workpiece with the liquid mixture, the liquid mixture being obtained by dispersing the fine particles in a solution of at least water and the adhesion promoting liquid; and a drying step of drying the liquid mixture on the one side of the workpiece by rotating the workpiece after performing the coating step, thereby forming the fine particle layer on the one side of the workpiece.

Preferably, the adhesion promoting liquid contains at least a surface active agent. Preferably, the absorptivity of the fine particles to the laser beam to be applied to the workpiece is higher than that of the one side of the workpiece.

In accordance with another aspect of the present invention, there is provided a fine particle layer forming agent for forming a fine particle layer on one side of a workpiece, the fine particle layer forming agent including a plurality of fine particles having absorptivity to the wavelength of a laser beam to be applied to the workpiece; an adhesion promoting liquid for promoting the adhesion of the fine particles to the one side of the workpiece; and water.

Preferably, the adhesion promoting liquid in the fine particle layer forming agent contains at least a surface active agent. Preferably, the absorptivity of the fine particles in the fine particle layer forming agent to the laser beam to be applied to the workpiece is higher than that of the one side of the workpiece.

In the laser processing method according to the present invention, the laser beam is applied to the one side of the workpiece in the condition where the one side of the workpiece is covered with the fine particle layer formed from the fine particles having absorptivity to the wavelength of the laser beam to be applied to the workpiece. Accordingly, the laser beam applied to the workpiece is absorbed by the fine particles forming the fine particle layer to reach the band gap energy of the fine particles, so that the atomic bond of the fine particles is broken. Accordingly, the energy of the laser beam reaches the band gap energy of the workpiece in a chained manner, so that the ablation is performed to the one side of the workpiece. In performing the ablation, the laser beam is absorbed by the fine particles forming the fine particle layer, thereby suppressing the scattering of the energy of the laser beam and the reflection of the laser beam. As a result, the processing efficiency can be improved over the prior art. Further, debris generated in performing the ablation is deposited to the fine particle layer, thereby reducing the possibility of deposition of the debris to the workpiece. After performing the laser processing, the fine particle layer is removed together with the debris from the workpiece, thereby preventing the deposition of the debris to the workpiece.

The protective film in the prior art (e.g., Japanese Patent Laid-open No. 2006-140311 mentioned above) is formed of synthetic resin such as PVA (polyvinyl alcohol) and PEG (polyethylene glycol). In contrast thereto, the fine particle layer formed from the fine particles having absorptivity to the wavelength of the laser beam functions as a protective film in the present invention. The fine particle layer forming agent according to the present invention is suitable for the formation of the fine particle layer mentioned above. In particular, by selecting the fine particles having high absorptivity to the wavelength of the laser beam, the processability can be improved over the prior art. Further, by suitably selecting the fine particles and the adhesion promoting liquid, the protective film can be formed from inorganic matter only. In this case, there is a merit that waste water disposal can be facilitated.

According to the present invention, the following effect can be exhibited. That is, it is possible to provide a laser processing method and a fine particle layer forming agent which can reduce the possibility of deposition of the debris due to ablation to the workpiece and can also improve the processing efficiency over the prior art.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a workpiece according to a preferred embodiment of the present invention;

FIG. 2A is a perspective view showing a condition that the workpiece is supported through an adhesive tape to an annular frame;

FIG. 2B is a sectional view of the workpiece in the condition shown in FIG. 2A;

FIG. 3 is a partially sectional side view showing a coating apparatus to be used in performing a laser processing method according to this preferred embodiment and also showing a holding step constituting a fine particle layer forming step of the laser processing method;

FIG. 4 is a view similar to FIG. 3, showing a coating step constituting the fine particle layer forming step;

FIG. 5 is a view similar to FIG. 3, showing a drying step constituting the fine particle layer forming step;

FIG. 6 is a perspective view showing a processing step of the laser processing method;

FIG. 7 is a sectional view showing the processing step; and

FIG. 8 is a view similar to FIG. 3, showing a step of cleaning the workpiece by using the coating apparatus after performing the processing step.

### DETAILED DESCRIPTION OF THE PREFERRED EMBODIMENT

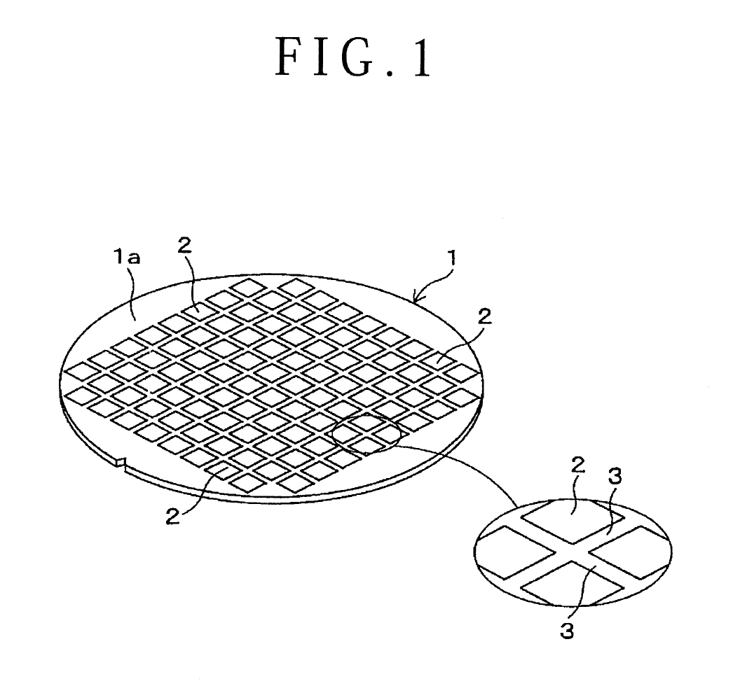

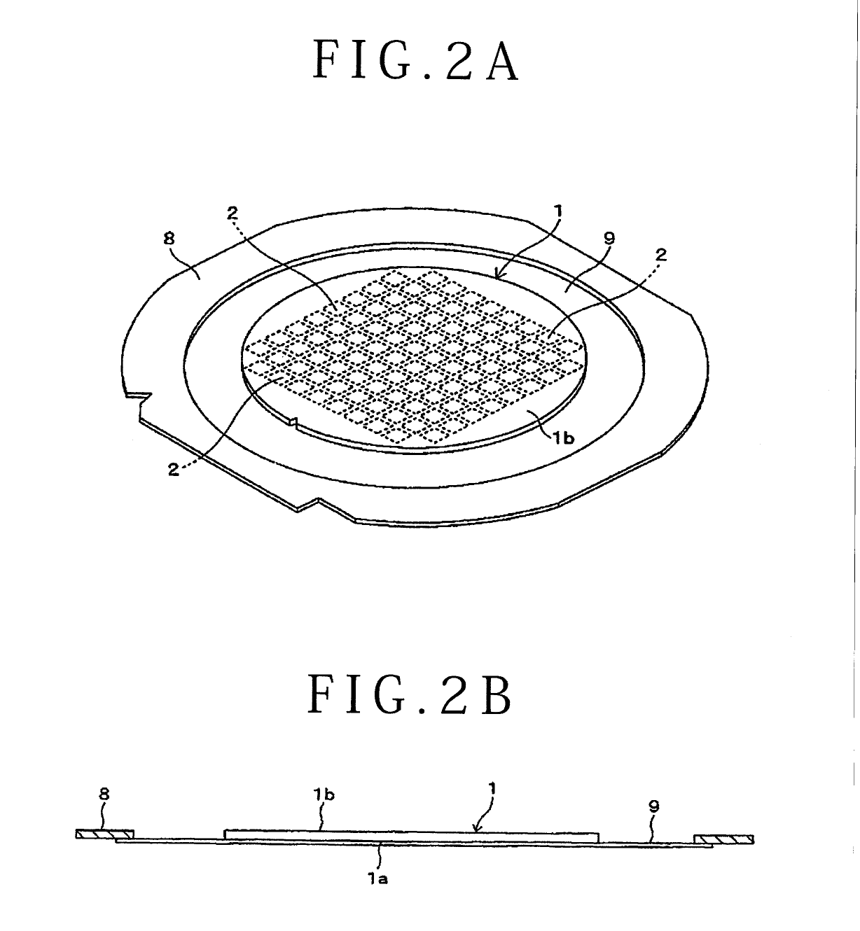

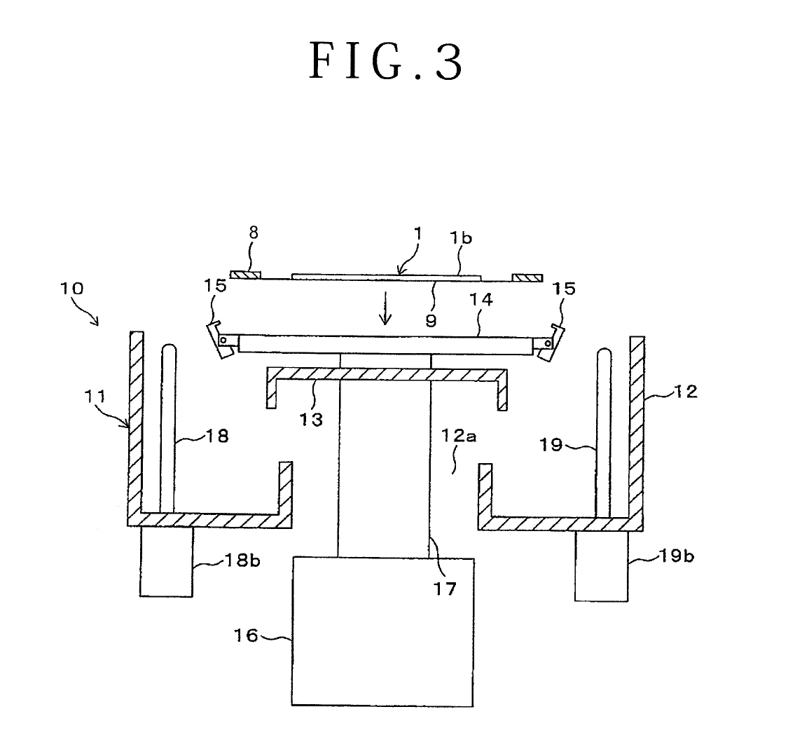

A preferred embodiment of the present invention will now be described with reference to the drawings. Reference numeral 1 in FIG. 1 and FIGS. 2A and 2B denotes a workpiece to be laser-processed in this preferred embodiment, and reference numeral 10 in FIGS. 3 to 5 denotes a coating apparatus for forming a fine particle layer as a protective film on the back side 1b of the workpiece 1 as one side to be irradiated with a laser beam.

### (1) Workpiece

The workpiece 1 shown in FIG. 1 is a disk-shaped sapphire substrate having a thickness of hundreds of micrometers, for example, and a plurality of optical devices 2 are formed from an epitaxial film on the front side 1a of the workpiece 1. A plurality of crossing division lines 3 are set on the front side 1a of the workpiece 1 to define a plurality of rectangular regions, in which the plural optical devices 2 are respectively formed. While the workpiece 1 is formed from a sapphire substrate in this preferred embodiment, the workpiece in the present invention is not limited to a sapphire substrate, but any substrate such as a semiconductor wafer and a glass plate may be used as the workpiece in the present invention.

As shown in FIGS. 2A and 2B, the front side 1a of the workpiece 1 is attached to an adhesive tape 9 supported to an annular frame 8. The adhesive tape 9 is composed of a base sheet and an adhesive layer formed on one side of the base sheet. The annular frame 8 is attached to the peripheral portion of the adhesive tape 9, and the workpiece 1 is attached to the central portion of the adhesive tape 9 so as to be positioned in concentrical relationship with the annular frame 8. That is, the workpiece 1 is attached to the adhesive tape 9 in the condition that the back side (one side) 1b of the workpiece 1 is exposed. The workpiece 1 thus supported through the adhesive tape 9 to the annular frame 8 is handled through the annular frame 8 and carried to the coating apparatus 10 shown in FIGS. 3 to 5.

### (2) Coating Apparatus

As shown in FIGS. 3 to 5, the coating apparatus 10 includes a cup-shaped case 11, a disk-shaped spinner table 14 provided in the case 11 for holding the workpiece 1, and a liquid agent nozzle 18 for supplying drops of a fine particle layer forming agent 30 in the form of a liquid to the back side 1b of the workpiece 1 held on the spinner table 14, wherein the spinner table 14 is rotated to form a fine particle layer 30A by spin coating. The coating apparatus 10 further includes a water nozzle 19 for supplying a cleaning water to the workpiece 1.

The case 11 is composed of a cylindrical case body 12 opening to the upper side and having a central hole 12a and a cover 13 for covering the central hole 12a of the case body 12. A drive shaft 17 of a motor 16 vertically extends through the cover 13 from the lower side thereof so as to be fixed to the cover 13. The spinner table 14 is concentrically fixed to the upper end of the drive shaft 17 projecting into the case 11 and thereby supported to the drive shaft 17 so as to be horizontally rotatable by the operation of the motor 16. The spinner table 14 is a vacuum chuck capable of holding the workpiece 1 under suction by producing a vacuum.

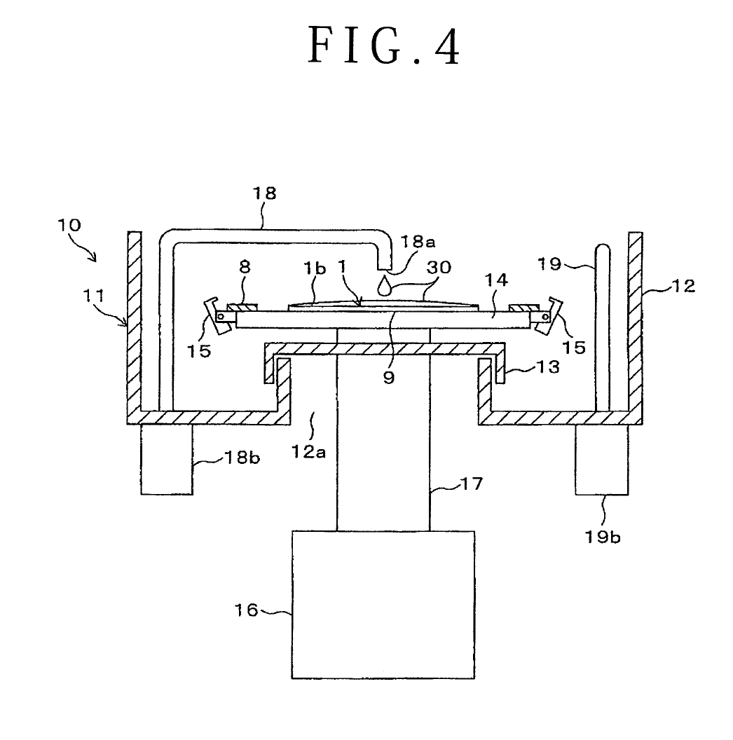

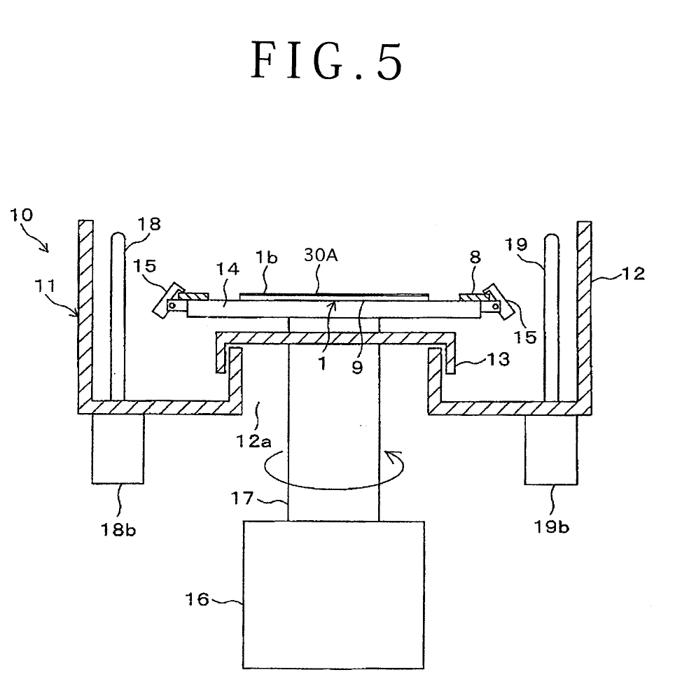

The motor 16 and the drive shaft 17 are supported to lifting means (not shown) so as to be vertically movable by the lifting means. Accordingly, by operating the lifting means, the spinner table 14 fixed to the drive shaft 17 is vertically moved between a load/unload position set near the upper opening of the case body 12 as shown in FIG. 3 and an operative position set inside the case body 12 as shown in FIGS. 4 and 5.

The workpiece 1 is concentrically placed through the adhesive tape 9 on the spinner table 14 and held under suction. A plurality of centrifugal clamps 15 are mounted on the peripheral portion of the spinner table 14 so as to clamp the annular frame 8 from the upper side thereof by using a centrifugal force produced by the rotation of the spinner table 14. Accordingly, the annular frame 8 is held on the spinner table 14 by these centrifugal clamps 15.

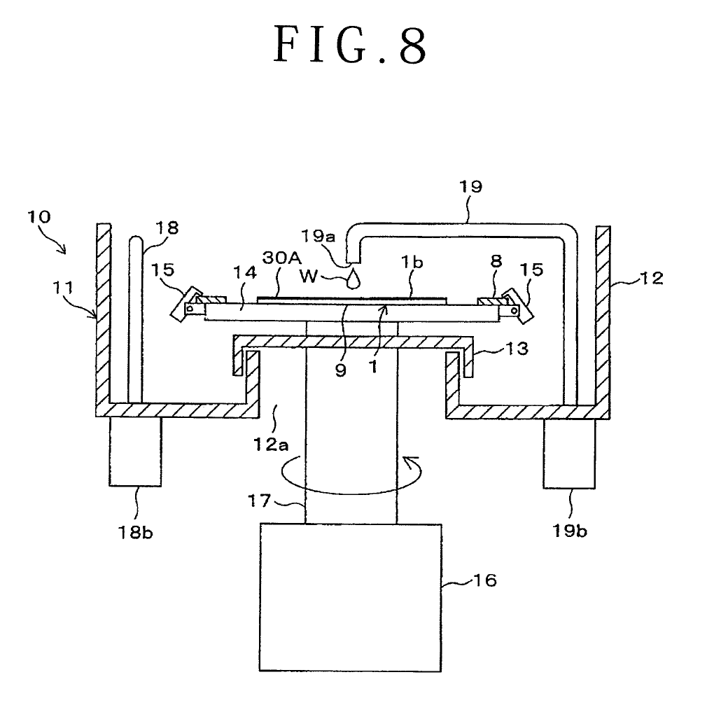

The liquid agent nozzle 18 and the water nozzle 19 have the same structure, and they are rotatably supported to the bottom portion of the case body 12. The liquid agent nozzle 18 and the water nozzle 19 have discharge openings 18a and 19a oriented downward, respectively (see FIGS. 4 and 8). The liquid agent nozzle 18 and the water nozzle 19 are adapted to be rotated by motors 18b and 19b, respectively, in such a manner that the discharge openings 18a and 19a are selectively positioned directly above the center of the spinner table 14.

### (3) Laser Processing Method

There will now be described a laser processing method for performing ablation to the workpiece 1 according to this preferred embodiment. This ablation is the process of applying a laser beam having a wavelength of 355 nm along the division lines 3 to thereby form a plurality of grooves along the division lines 3. The laser beam having a wavelength of 355 nm is hardly absorbed by sapphire forming the workpiece 1. Prior to performing this ablation, a fine particle layer is formed on the back side 1b of the workpiece 1 as one side to be irradiated with the laser beam. This fine particle layer is formed by using a fine particle layer forming agent to be hereinafter described.

### (3-1) Fine Particle Layer Forming Agent

The fine particle layer is formed by supplying a fine particle layer forming agent from the liquid agent nozzle 18 to the back side 1b of the workpiece 1. The fine particle layer forming agent is a liquid mixture composed of a plurality of fine particles having absorptivity to the wavelength of the laser beam to be applied to the workpiece 1, an adhesion promoting liquid for promoting the adhesion of the fine particles to the back side 1b of the workpiece 1, and water.

The fine particles have absorptivity to the laser beam to be applied to the workpiece 1. Preferably, the absorptivity of the fine particles to the laser beam is higher than that of the back side 1b of the workpiece 1 as one side to be irradiated with the laser beam. In the case that the wavelength of the laser beam to be applied to the workpiece 1 is 355 nm as described above, the fine particles may be selected from silica (SiO₂), titanium oxide (TiO₂), iron (II) oxide (FeO), iron (III) oxide (Fe₂O₃), tin oxide (SnO), zinc oxide (ZnO), and carbon, for example. These materials are preferable because there is no possibility of metal contamination to the workpiece 1 and the optical devices 2. In particular, silica is more preferable because it is inexpensive, resulting in low manufacturing cost and good economy.

The adhesion promoting liquid may be selected from PVA (polyvinyl alcohol), PEG (polyethylene glycol), PEO (polyethylene oxide), PVP (polyvinyl pyrrolidone), and various celluloses, for example. Preferably, the adhesion promoting liquid includes a surface active agent having an anti-sag property. In addition to the surface active agent, a thickener, gelling agent, and stabilizer formed of synthetic resin or high-molecular compound may be preferably included in the adhesion promoting liquid.

Preferably, the particle size of the fine particles is smaller than the spot diameter of the laser beam on the workpiece 1. For example, the particle size of the fine particles is set to 5 to 30 nm. In performing laser processing to the workpiece 1, alignment is performed to detect the division lines 3 along which the laser beam is to be applied. This alignment is performed according to an image obtained by applying light to the workpiece 1. If the particle size of the fine particles is larger than 30 nm, the workpiece 1 becomes opaque to visible light in performing the alignment, so that the detection of the division lines 3 becomes difficult. For this reason, the particle size of the fine particles is preferably set to 5 to 30 nm. However, in the case of using light having a transmission wavelength to the fine particles in performing the alignment, the detection of the division lines 3 is allowed. In this case, the particle size of the fine particles may be larger than 30 nm.

For example, the mixing ratio among the fine particles, the adhesion promoting liquid, and the water is set to 5 to 20 vol % for the fine particles, 0.1 to 10 vol %, preferably, 0.1 to 7 vol % for the adhesion promoting liquid, and the remainder for the water. At this mixing ratio, the fine particles in the form of powder may be dispersed in a liquid mixture of the water and the adhesion promoting liquid to thereby produce the fine particle layer forming agent. In this case, a dispersing agent for preventing the aggregation of the fine particles is preferably mixed at a suitable ratio. In the case that inorganic matter is used for the fine particle layer forming agent, there is a merit such that it is unnecessary to dispose of any hazardous matter, thereby facilitating the waste water disposal after using the fine particle layer forming agent.

As another method of producing the fine particle layer forming agent, a sol or colloidal solution produced by an alkoxide method, for example, may be used as the fine particles. In this case, the fine particles in the form of a sol or colloidal solution are mixed with the adhesion promoting liquid and the water to produce the fine particle layer forming agent. Since the fine particles are produced by an alkoxide method in this case, ultrafine particles having a uniform particle size can be obtained and the fine particles can be uniformly dispersed in the liquid mixture. In some cases, the fine particle layer forming agent may be produced from only the fine particles in the form of a sol or colloidal solution, wherein the sol or colloidal solution functions as the adhesion promoting liquid. Further, in such cases, water may be added to the sol or colloidal solution to thereby improve the coating property.

### (3-2) Fine Particle Layer Forming Step

The fine particle layer forming agent in the form of a liquid as produced above is supplied to the back side 1b of the workpiece 1 by using the coating apparatus 10 to thereby cover the back side 1b of the workpiece 1 with the fine particles having absorptivity to the wavelength of the laser beam. The operation of the coating apparatus 10 will now be described. First, as shown in FIG. 3, the workpiece 1 is concentrically placed through the adhesive tape 9 on the spinner table 14 raised to the load/unload position in the condition where the back side 1b of the workpiece 1 is exposed upward. Further, the annular frame 8 is also placed on the spinner table 14.

As shown in FIG. 4, the spinner table 14 is lowered to the operative position, and the workpiece 1 is held under suction on the spinner table 14 (holding step). Thereafter, the liquid agent nozzle 18 is rotated to position the discharge opening 18a directly above the center of the workpiece 1, and the fine particle layer forming agent (liquid mixture) 30 is supplied in the form of drops by a predetermined amount from the discharge opening 18a to the center of the back side 1b (upper surface) of the workpiece 1. Thereafter, the spinner table 14 is rotated at a low speed (e.g., 10 rpm) to thereby rotate the workpiece 1. As a result, the fine particle layer forming agent 30 is spread over the entire surface of the back side 1b of the workpiece 1 by a centrifugal force, thereby uniformly covering the back side 1b (coating step). As a modification, the spinner table 14 may be preliminarily rotated and the fine particle layer forming agent 30 may be next supplied to the workpiece 1 being rotated.

Thereafter, as shown in FIG. 5, the liquid agent nozzle 18 having already stopped the supply of the fine particle layer forming agent 30 is retracted, and the rotational speed of the spinner table 14 is increased. In this condition, the spinner table 14 is rotated at a high speed for a predetermined time, thereby driving off the water contained in the fine particle layer forming agent 30, that is, drying the fine particle layer forming agent 30. At this time, the annular frame 8 is held by the centrifugal clamps 15. For example, the rotational speed of the spinner table 14 is set to 2000 rpm and the rotational time of the spinner table 14 is set to 60 seconds. By drying the fine particle layer forming agent 30 as described above, the fine particle layer 30A having a uniform thickness is formed on the back side 1b of the workpiece 1 (drying step).

The thickness of the fine particle layer 30A may be set as required, for example, to 2 to 4 μm. As a modification, the coating step and the drying step may be repeated until the fine particle layer having a desired thickness is obtained. For example, in the case of forming the fine particle layer having a relatively large thickness, the uniform thickness of the fine particle layer can be obtained by repeating the coating step and the drying step plural times rather than by once performing the coating step and the drying step.

### (3-3) Processing Step

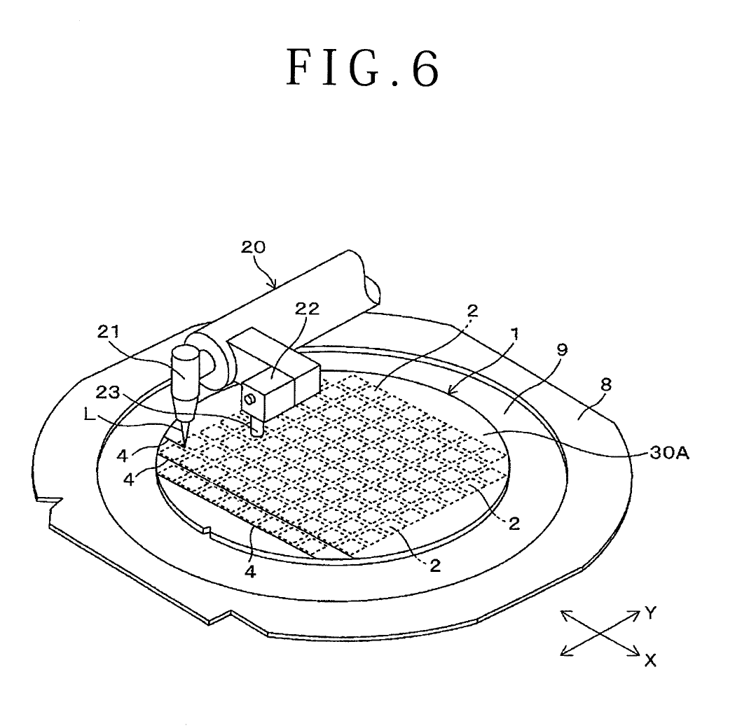

After forming the fine particle layer 30A having a desired thickness on the back side 1b of the workpiece 1, the workpiece 1 is unloaded from the coating apparatus 10 and then loaded to a processing apparatus having laser processing means 20 shown in FIG. 6 to perform the ablation by applying a laser beam L through the fine particle layer 30A to the back side 1b of the workpiece 1 along the division lines 3 to thereby form a plurality of grooves 4 on the back side 1b along the division lines 3.

The laser processing means 20 shown in FIG. 6 has a laser applying unit 21 for applying the laser beam L downward to the workpiece 1 and alignment means 22 fixed to the laser applying unit 21. The alignment means 22 functions to detect the division lines 3 of the workpiece 1 and it includes a camera 23 for imaging the workpiece 1. The laser applying unit 21 functions to apply the laser beam L having a wavelength of 355 nm that is hardly absorbed by sapphire forming the workpiece 1. The other conditions of the laser beam L are set to 0.5 to 1.5 kW for the average power and 90 kHz for the repetition frequency.

Although not shown, rotatable holding means for holding the workpiece 1 is provided below the laser processing means 20. The workpiece 1 supported through the adhesive tape 9 to the annular frame 8 is horizontally held by the holding means in the condition where the back side 1b of the workpiece 1 is exposed upward. The annular frame 8 is also held by the holding means. The laser processing means 20 and the workpiece 1 held by the holding means are relatively movable both in a feeding direction shown by an arrow X and in an indexing direction shown by an arrow Y in FIG. 6.

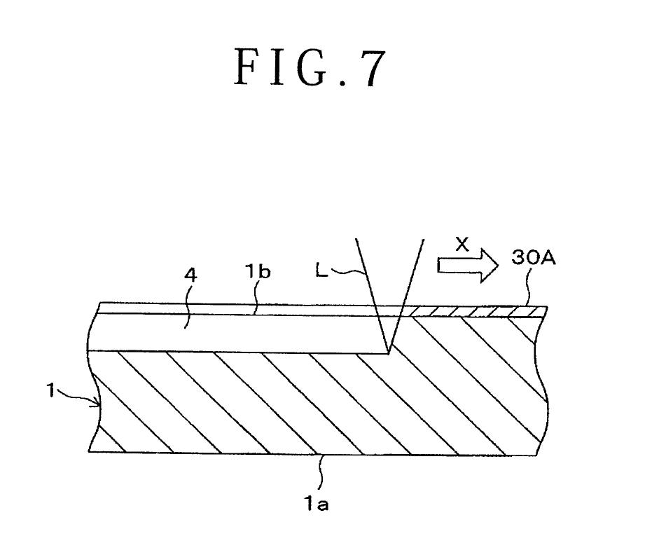

In performing the laser processing, the workpiece 1 is first imaged by the alignment means 22 to detect the division lines 3. Thereafter, according to the result of this detection, the holding means is rotated to make the division lines 3 extending in a first direction parallel to the feeding direction (X direction), and next moved in the indexing direction (Y direction) to select one of the division lines 3 extending in the first direction along which the laser beam L is to be applied. Thereafter, as shown in FIG. 7, the laser beam L is applied through the fine particle layer 30A to the back side 1b of the workpiece 1 along this selected division line 3 while being scanned in the X direction at a predetermined speed (e.g., 120 mm/s), thereby performing the ablation to the back side 1b to form the groove 4 having a predetermined depth along this selected division line 3. After performing this ablation along the selected division line 3 as described above, the workpiece 1 is indexed in the Y direction by the pitch of the division lines 3 and then fed in the X direction as applying the laser beam L along the next division line 3 extending in the first direction, thereby similarly performing the ablation to form the groove 4. Thereafter, the indexing operation and the feeding operation are alternately repeated with the application of the laser beam L to similarly form the grooves 4 along all of the other division lines 3 extending in the first direction.

After performing the ablation along all of the division lines 3 extending in the first direction as described above, the holding means is rotated 90° to make the remaining division lines 3 extending in a second direction parallel to the X direction. Thereafter, the ablation is similarly performed by applying the laser beam L along the division lines 3 extending in the second direction.

Thus, the ablation in this processing step is a grooving step. After forming the grooves 4 on the back side 1b of the workpiece 1 along all of the division lines 3, the processing step is finished and the workpiece 1 is loaded again to the coating apparatus 10 to remove the fine particle layer 30A from the workpiece 1. More specifically, as shown in FIG. 8, the water nozzle 19 is rotated to position the discharge opening 19a directly above the center of the workpiece 1. In this condition, a cleaning water W is supplied from the discharge opening 19a to the fine particle layer 30A left on the back side 1b of the workpiece 1, and the spinner table 14 is rotated to remove the fine particle layer 30A from the workpiece 1. Thereafter, the rotation of the spinner table 14 is continued to dry the workpiece 1. For example, the spinner table 14 is rotated at 800 rpm for 20 seconds in cleaning the workpiece 1, and next rotated at 2000 rpm for 60 seconds in drying the workpiece 1.

After finishing the cleaning operation and the drying operation as described above, the workpiece 1 is unloaded from the coating apparatus 10. Thereafter, an external force is applied to the workpiece 1 to thereby break the workpiece 1 along the division lines 3 where the grooves 4 are respectively formed to thereby reduce the strength. As a result, the workpiece 1 is divided into the plural optical devices 2.

### (4) Operation and Effect of the Preferred Embodiment

In the laser processing method according to the above preferred embodiment, the laser beam L is applied to the back side 1b of the workpiece 1 in the condition where the back side 1b is covered with the fine particle layer 30A formed from the fine particles having absorptivity to the wavelength of the laser beam L to be applied to the workpiece 1, wherein the absorptivity of the fine particles is higher than that of the back side 1b of the workpiece 1. Accordingly, the laser beam L applied to the workpiece 1 is absorbed by the fine particles forming the fine particle layer 30A to reach the band gap energy of the fine particles, so that the atomic bond of the fine particles is broken. Accordingly, the energy of the laser beam L reaches the band gap energy of the workpiece 1 in a chained manner, so that the grooves 4 are formed by the ablation on the back side 1b of the workpiece 1 as the laser beam applied surface along the division lines 3.

In general, the back side 1b of the workpiece 1 formed as a sapphire substrate having the plural optical devices 2 on the front side 1a is a mirror surface, so that if the laser beam L is applied directly to the back side 1b of the workpiece 1, the laser beam L may be reflected on the back side 1b to result in difficulty of laser processing. To cope with this problem, the fine particle layer 30A having absorptivity to the laser beam L having a wavelength of 355 nm is formed on the back side 1b of the workpiece 1 in this preferred embodiment, so that the ablation is started from the fine particle layer 30A. In performing the ablation, the laser beam L is absorbed by the fine particles forming the fine particle layer 30A, thereby suppressing the scattering of the energy of the laser beam L and the reflection of the laser beam L. As a result, the processing efficiency can be improved.

Further, debris generated in performing the ablation is deposited to the fine particle layer 30A, thereby reducing the possibility of deposition of the debris to the workpiece 1. After performing the laser processing, the fine particle layer 30A is washed away from the workpiece 1, so that the debris can be removed together with the fine particle layer 30A, thereby preventing the deposition of the debris to the workpiece 1.

In the case that the laser processing method of the present invention improved in processing efficiency is applied to a workpiece requiring high energy for processing, such as a semiconductor wafer having an oxide film, TEG (Test Element Group), etc., it is unnecessary to apply a laser beam to such a workpiece at high energy. Accordingly, the present invention is effective in this case. Particularly when a laser beam is applied at high energy to a wafer having a TEG, there is a problem that an area of the wafer where the TEG is not formed may be roughened by the laser beam, causing a reduction in processing quality. However, the present invention can solve such a problem.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing method of applying a laser beam to a workpiece to thereby perform ablation, said laser processing method comprising:
a fine particle layer forming step of covering one side of said workpiece with fine particles having absorptivity to the wavelength of said laser beam to be applied to said workpiece, thereby forming a fine particle layer on the one side of said workpiece; and
a processing step of applying said laser beam through said fine particle layer to said workpiece after performing said fine particle layer forming step, thereby performing the ablation to the one side of said workpiece.

2. The laser processing method according to claim 1, wherein said fine particle layer includes said fine particles and an adhesion promoting liquid for promoting the adhesion of said fine particles to the one side of said workpiece.

3. The laser processing method according to claim 2, wherein said fine particle layer forming step includes:
a holding step of rotatably holding said workpiece on a spinner table;
a coating step of supplying a liquid mixture to the one side of said workpiece after performing said holding step, thereby coating the one side of said workpiece with said liquid mixture, said liquid mixture being obtained by dispersing said fine particles in a solution of at least water and said adhesion promoting liquid; and
a drying step of drying said liquid mixture on the one side of said workpiece by rotating said workpiece after performing said coating step, thereby forming said fine particle layer on the one side of said workpiece.

4. The laser processing method according to claim 2, wherein said adhesion promoting liquid contains at least a surface active agent.

5. The laser processing method according to claim 1, wherein the absorptivity of said fine particles to said laser beam to be applied to said workpiece is higher than that of the one side of said workpiece.

6. A fine particle layer forming agent for forming a fine particle layer on one side of a workpiece, said fine particle layer forming agent comprising:
a plurality of fine particles having absorptivity to the wavelength of a laser beam to be applied to said workpiece;
an adhesion promoting liquid for promoting the adhesion of said fine particles to the one side of said workpiece; and
water.

7. The fine particle layer forming agent according to claim 6, wherein said adhesion promoting liquid contains at least a surface active agent.

8. The fine particle layer forming agent according to claim 6, wherein the absorptivity of said fine particles to said laser beam to be applied to said workpiece is higher than that of the one side of said workpiece.
